(19) United States
(12) Patent Application Publication
(10) Pub. No.: US 2005/0160090 A1
(43) Pub. Date: Jul. 21, 2005

(54) Method and system for accessing database objects in polyarchical relationships using data path expressions

(75) Inventor: Andy Harjanto, Sammamish, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 11/064,578

(22) Filed: Feb. 24, 2005

Related U.S. Application Data
(63) Continuation of application No. 10/620,095, filed on Jul. 15, 2003.

(51) Int. Cl. G06F 7/00

(52) U.S. Cl. 707/3

(57) ABSTRACT

A method and system for accessing objects in a network database uses a location path expression in a database query to indicate how the desired data may be located. Relationships linking attributes of the database objects are defined as path links to allow the viewing of different types of relations among the object attributes using the same set of data, i.e., in a polyarchical manner. Location path expressions are formed based on the defined path links between the object attributes. Each location path expression includes a view name that specifies a relationship to be used to view the data, and path elements identifying a path to the desired data based on the path links provided by the relationship. A search engine is provided to parse the location path string and carry the search operation for the requested data.

### TECHNICAL FIELD

This invention relates generally to computer networks, and more particularly to the operations of accessing a database, such as a network directory service, to locate objects in the database.

### BACKGROUND OF THE INVENTION

Web services are a new and rapidly growing technology that promises to revolutionize the way business-to-business and business-to-consumer services are provided and used. Web services comprise web-based applications that dynamically interact with other Web applications. At the core of the Web services is the EXtensible Markup Language (XML), which is an open standard from the World Wide Web Consortium (W3C). XML is used for defining data elements on a Web page and business-to-business documents, and provides a mechanism for communication with the Web services. An XML document uses tags to define data elements and attributes that are arranged in a hierarchical structure. For processing XML documents, the XML Path Language (XPath) has been developed to identify tagged XML elements and their attributes in an XML document, and to calculate numbers and manipulate strings. The syntax of an XPath expression is similar to the directory addressing used in certain operating systems, which use a slash for the root directory as well as the separator between nodes on adjacent hierarchy levels.

Directory service is one of the most common types of network services used in the Internet or other large networks. Various network entities are typically represented in the directory service database by objects of different types. Directory service protocols, such as the Lightweight Directory Access Protocol (LDAP), have been developed for accessing the directory service database to perform directory operations on the objects in the database. Generally, the directory access according to LDAP is based on the application of filters, with each query using a filter to select objects. Moreover, LDAP is session-based, and each session may include a sequence of queries to locate the desired objects.

The directory service database contains many different types of objects, which have their respective attributes. Generally, to maximize the usefulness of the data stored in the database, it is desirable to be able to view the data based on various types of relationships among the data items beyond the basic hierarchical structure of the database. This concept of viewing different types of relationships with the same set of data is called polyarchy. In this regard, it is further desirable to provide a simple and flexible way for a client to specify in a request the kind of data it wants to locate based on polyarchical relationships. Current database access protocols such as the LDAP, however, do not lend themselves readily to this task.

### SUMMARY OF THE INVENTION

In view of the foregoing, the present invention provides a method and system for accessing objects in a network database that uses a location path expression in a database query to indicate how the desired data may be located. To support such path expressions, relationships linking attributes of the database objects are defined as link paths. This allows the viewing of different types of relations among the object attributes using the same set of data, i.e., in a polyarchical manner. Location path expressions may be formed based on the defined path links between the object attributes. The location path expression includes a view name that identifies the attribute relationship on which the viewing is based, and a plurality of attribute values in a hierarchical manner. A database query including such a location path expression is sent to a database access engine. The database access engine parses the data path expression and generates corresponding directory access requests for locating objects along the path specified in the location path expression to retrieve the desired data.

### BRIEF DESCRIPTION OF THE DRAWINGS

FIG. 1 is a block diagram generally illustrating an exemplary computer system that may be used to implement the clients or servers for database access in accordance with the invention;

FIG. 2 is a schematic diagram showing an embodiment of the invention having a Web service for accessing a directory service database using path expressions similar to XPath location path expressions.

FIG. 3 is a schematic diagram showing an exemplary hierarchical database structure having objects as its nodes;

FIG. 4 is a schematic diagram showing exemplary relationships defined among the attributes of directory objects to support polyarchical access of the objects;

FIG. 5 shows the syntax of location path expressions used in an embodiment of the invention for identifying a path to objects in a database;

FIG. 6 is a schematic diagram showing a network client using location path expressions to access a directory database through a Web service; and

FIG. 7 is a schematic diagram showing an alternative embodiment in which a network client accesses a directory database using location path expressions.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

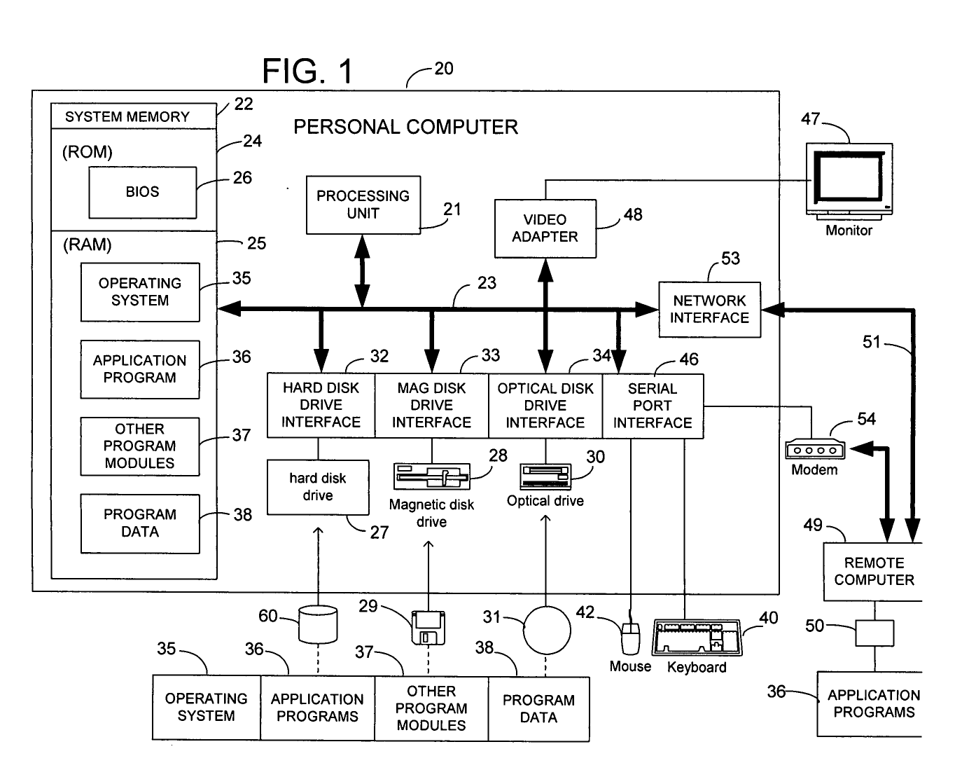

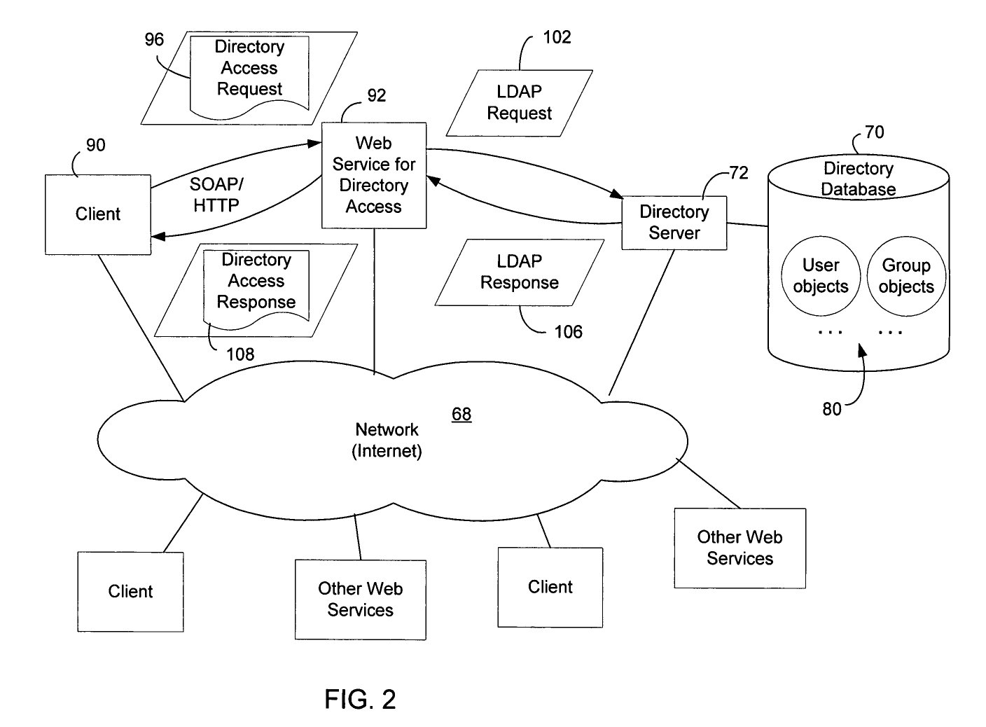

The following description begins with a description of a general-purpose computing device that may be used for implementing either a client or a server in an embodiment of a system of the invention for accessing directory data, and the system of the invention and its operation will be described in greater detail with reference to FIGS. 2-7. Turning now to FIG. 1, a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31, such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, a game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those skilled in the art will appreciate that various of the acts and operations described hereinafter may also be implemented in hardware.

The present invention is directed to a new approach to accessing objects in a database, such a directory service database, by expressing the relationships among attributes of the objects in the database to allow the objects in the database to be located based on different types of relationships among the object attributes. This concept of viewing different types of relationships with the same set of data is termed “polyarchy.” The polyarchy concept of the invention enables clients to query and access the database objects in ways that are much more powerful than conventional database queries, such as LDAP filters even the Structured Query Language (SQL) queries. As a direct result of the polyarchical arrangement of the database, a new form of database query expression can be used to identify a path through the database objects for locating the desired data. Such an expression of a path is hereinafter referred to as a “location path expression.”

As will be explained in greater detail below, in a preferred embodiment, the syntax of the location path expression for accessing database objects in accordance with the invention looks somewhat similar to that of the XML Path Language (XPath), which is for identifying particular parts of XML documents. It must be appreciated, however, that the present invention should not be viewed as a straightforward or obvious application of XPath, because XPath is developed for viewing XML documents, which are not analogous to a database containing objects of different types. Also, it should be appreciated that the invention does not limit itself to data structured like XML documents, and the use of location path expressions for database access in accordance with the invention can be easily applied to various database structures that support hierarchical relationships among the attributes of the database objects.

Before describing the implementation of polyarchy for objects in a database, an exemplary system implementing an embodiment of the invention is described first. Referring now to FIG. 2, in a preferred embodiment, the database to be accessed is a directory service database 70. It will be appreciated, however, that the polyarchical database access of the invention can be readily applied to other types of databases. The directory service database 70 is typically part of a distributed database system that includes a plurality of local databases distributed over a network 68, such as the Internet. The directory service database 70 stores many directory objects 80 of a plurality of different types relevant to the function of providing directory service to clients on the network. For instance, the object types may include User, Group, Computer etc, representing different types of network entities, and various other object types for administration purposes. Each directory service database 70 is managed by an associated directory server 72, which provides directory service by performing directory operations, such as creation, retrieval, update, delete, search, etc., in response to directory service requests from clients 90 on the network.

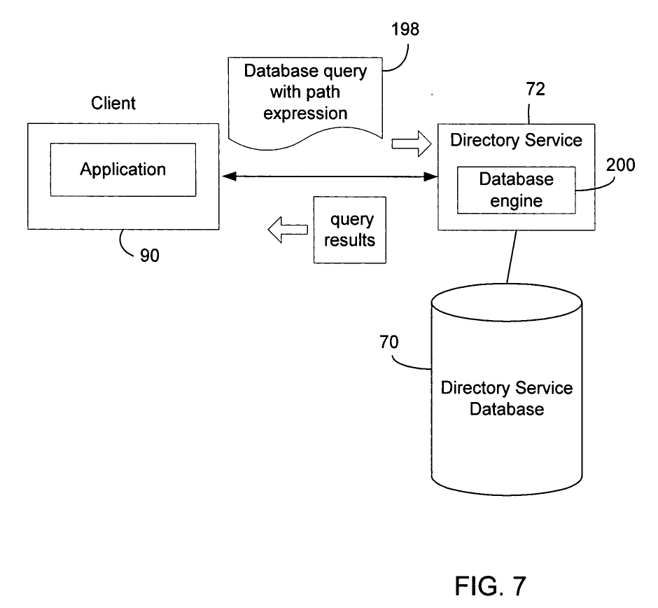

In accordance with an aspect of the embodiment, to enable network clients 90 to access the directory service in accordance with a Web services model, a Web service 92 for directory access is provided. As will be described later with reference to FIG. 7, however, the invention is not limited to Web services, and in an alternative embodiment a client may talk to the directory service 72 directly. Although only one Web service for directory access is shown in FIG. 2, it will be appreciated that multiple Web services for that purpose may be deployed on the network 68. The Web service 92 functions as an interface (or intermediary) between the clients 90 and the directory server 72, and communicates with the network clients in accordance with the Web services model. To access the directory data, the clients 90 send their directory requests 96 to the Web service 92. The Web service 92 then converts the directory requests into queries according to a pre-selected directory access protocol, such as LDAP (“Lightweight Directory Access Protocol), that is supported by the directory server 72, and initiates a session with the directory server 72 in which the LDAP queries 102 are presented to the directory server. After the directory server 72 returns the results 106 in response to the LDAP queries, the Web service 92 converts the results into the format according to the Web services standards, and sends the response message 108 to the client 90. In this regard, the communications between the Web service 92 and the client 90 typically use SOAP over HTTP as the transport.

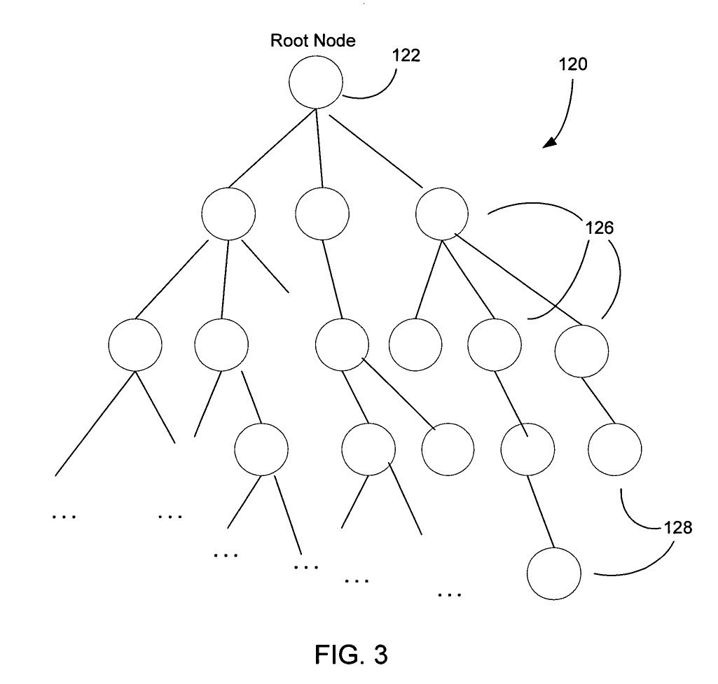

Referring now to FIG. 3, in one embodiment, the directory service database is implemented using a hierarchical containment model. In other words, the objects in the directory service database are arranged into a tree-like structure 120, with a root node 122 and multiple layers of branch nodes 126 and leaf nodes 128, each node corresponding to an object in the database. The root node or any branch node in the tree may have multiple child nodes, which in turn may have their own child nodes. Each parent node is linked to its child nodes.

Although the directory hierarchy indicates parent-child relationships between the directory objects, there are many other types of relationships among the attributes of the objects that, although existing conceptually, are not identified by the hierarchy, and such relationships are often difficult to identify by examining the graph of the directory hierarchy. For instance, a manager in a corporation may have a plurality of employees that report to her. In that case, the user object representing the manager may have an attribute in the form of an array called “DirectReports,” with each array element identifying the name or ID of an employee that directly reports to the manager. Similarly, the user object for the employee reporting to the manager may have a data member called “manager” that indicates the name or ID of the manager. The relationship between the “manager” attribute and the “DirectReports” attribute, however, is not explicitly identified and may not be ascertained by checking the attribute names.

Conventionally, directory search operations for the directory service are based on a simple attribute-matching model, and the instructions for performing the searches, such as those according to the LDAP, reflect that approach. For instance, to find the addresses of people reporting to Jane Smith in Fabrikam Corporation, one directory access instruction may be given to find the object for Jane Smith by matching the name “Jane Smith” with the name attribute of user objects identified as employees of Fabrikam Corporation. Once the Jane Smith object is found, its “DirectReports” array is retrieved to identify the names of employees reporting to Jane Smith. Another directory access instruction may then be given for each employee reporting to Jane Smith to find the object with that employee's name. It can be seen that the task of obtaining a simple type of needed information may require the use of multiple database access instructions, and sometimes the instructions have to be recursively performed to obtain the desired information. If the directory access instructions have to be issued by a network client, the client has to have the proper programming logic to carry out the sequence of instructions for retrieving the desired information. This can put a significant burden on the client device (and its software developers), and the network traffic becomes very “chatty” in the process of traversing the relationships. Moreover, to properly form the instructions to accomplish the task, the client has to know how the objects in the directory database are linked to one another, and that requirement is often difficult to meet.

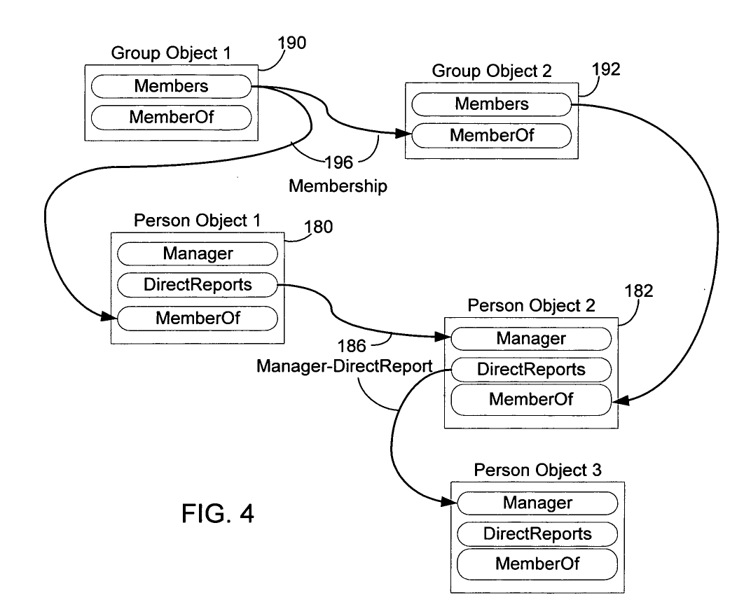

In accordance with the invention, a link between the attributes of two objects can be created to provide a path from one attribute to the other, and such link paths between attributes provides a powerful tool for accessing the data of objects in a database according to different types of relationships beyond the hierarchical relationship of the database. To illustrate this concept, FIG. 4 shows two examples of relationships defined between object attributes. These two relationships are “Manager-DirectReports” relationship and “Group Membership” relationship. The Manager-DirectReports relationship is defined between two objects of the “person” class. In this example, each object derived from the class “person” includes a “Manager” attribute and a “DirectReports” attribute. The “Manager” attribute points to the manager of the person represented by the object, and the “DirectReports” attribute contains a pointer to each of the persons directly reporting to this person. For illustration, FIG. 4 shows two person objects 180 and 182. The Manager-DirectReports relationship, denoted as 186, is defined by linking the Manager attribute of the Person object 182 to the DirectReports attribute of another Person object 180 to whom the person of the object 182 reports directly. The Group Membership relationship is defined among a Group object 190 representing a group and members of the group. The group members may be person objects, such as the person object 180, or other Group objects, such as the Group object 192. Each Group object includes two attributes: Members and MemberOf, and the Person object includes a MemberOf attribute. The Members attribute points to members of the group, and the MemberOf attribute points to the Group object for the group of which the current object is a member. The Group Membership relationship, denoted as 196, is defined by linking the Members attribute of a Group object to the MemberOf attribute of a member of the group. Even though FIG. 4 shows only two types of relationships, it will be appreciated that many other types of relationships may be defined among the various attributes of the objects in the database.

In accordance with a feature of the invention, once the relationships between attributes of the classes for the database objects are defined, they can be used for locating objects and their attributes in the database by providing a path that uses the relationships between the attributes to lead to the desired data. This new approach to expressing a query for database access is significantly different from the conventional model, such as LDAP, for accessing data in a database. As will become clear from the discussion below, this new enables the use rich, multi-attribute, queries on a directory service or similar databases containing different types of objects with linked attributes. Rich queries can be formed that are difficult to do using conventional directory service query approaches. For instance, as will be explained in greater detail below, the query expressions in may be along the line of “list those employees reporting to Steve Smith who are allowed access to resource B.”

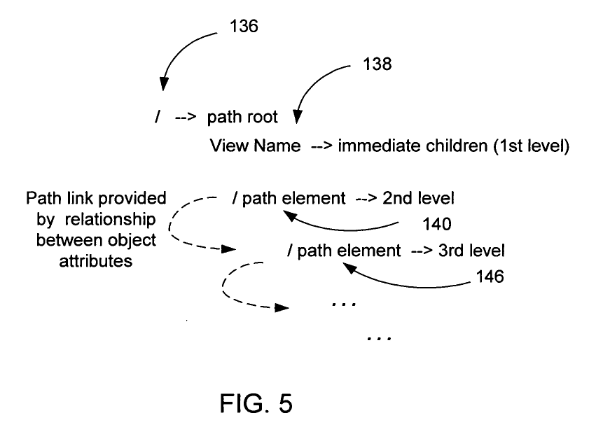

Referring to FIG. 5, in a preferred embodiment, the path expressions for locating desired database data have a format that is generally similar to the syntax of the XML PATH Language (XPath). XPath is defined in XML Path Language Version 1.0 by World Wide Web Consortium (W3C), which is hereby incorporated by reference in its entirety. XPath is a component of the Extensible Stylesheet Language (XSL) that is used to identify tagged XML elements and attributes in an XML document. It is also used to calculate numbers and manipulate strings. As shown in FIG. 5, the data path expression starts with a root node of the path, represented by the backslash (“/”) symbol. Following the root node symbol 136 is “ViewName” parameter 138. The ViewName is followed by a path element 140, which is separated from the ViewName by a forward slash. The path element 140 may be followed by another path element 146, and so on, with the string of path elements separated by forward slashes. Each of the path element forms a node in the search path and may be the attribute value of a database object, or special symbols, such as wildcard symbols or reverse search, etc., to indicate a search strategy.

Each ViewName parameter in the data path expression represents a “view” based on a predefined relationship between object attributes. The definition of the ViewName is in the configuration data of the server and describes the following things:
The name of the “View.” For instance, the view name may be “OrgChart.”
The attribute relationship on which the view is based. For instance, the OrgChart view may be based on the Manager-DirectReports relationship.
Where the logical root should start. This defines the scope of the view and provides added security and performance benefits, since the user should not be able to view beyond the logical root. For example, if a view is defined for identifying Person objects pertaining to a particular engineering project, then there is no need to include the CEO of the company in the view and the logical root may start at the leader of the project.
Who has access to the view. This provides access control by specifying who has permission to traverse and query the database using this particular view.
Optional Configuration such as default values for Size Limit, Time Limit, Page Size, etc.
   The configuration information for the set of ViewName parameters available for accessing the directory service database is preferably published in a public database to allow clients on the network to learn about the views so that they can construct the data path expression.

By way of example, various examples of the data path expressions for accessing the directory service objects are provided below. The examples in the first set include “simple” location paths in that they follow a straightforward hierarchical path to a specified object and do not use wildcard symbols.
/Enterprise/Business/US/Central/MidWest/Chicago
/Employee/BarbM/ChuckK/DavidD/EdwardE
/ServerGroupEmployee/TomS/JSmith
/AutoGroup/PaulGroupFT/DaveGroup/PeterEmployees
/Projects/Fabrikam/Manufacturer/Powertrain
/Office/US/Redmond/40/5234
/Printer/US/SEA/40/5/COPRXXA
/Identity/guid-2CC7C7B2-9B2D-11d3-9099-00A0C9E71419
/MyUDDI/MyBusiness/MyServices/2CC7C7B2-9B2D-11d3-9099-00A0C9E71439/5FD7C7B2-9A2D-31d3-9099-18A0C9E71439

In the examples above, the path expressions are in the abbreviated form. They can also be expressed in the unabbreviated form, wherein each location step in the path has two required parts: an axis and a node test, separated by a double colon (::), as in unabbreviated XPath expressions. For instance, the abbreviated path: Enterprise/business/ may also be written as: child::Enterprise/child::Business.

The following data path expression examples are more complicated than the simple paths shown above due to the use of wildcard features. The wild card symbols and their usage are similar as in XPath expressions. For instance, the asterisk (*) matches any object node regardless of its name. Also, the double forward slash (//) selects from all descendants of the context node, as well as the context node itself, and the @ sign followed by an attribute name is used to select a particular attribute of that name of the context node object.

| | |
|---|---|
| 1. | All employees under DaveD. |
| | /ServerGroupEmployee/DaveD//* |
| 2. | All employees under DaveD that work in the Directory Services Project. |
| | /ServerGroupEmployee/DaveD//*[@ProjectName=’Directory Service’] |
| 3. | Recursively, selecting all security-enabled groups the user named Smith (who is in |
| | ChuckM's Organization) belongs to. |
| | /ServerGroupEmployee/DaveD/ChuckM//[@LastName=’Smith’]/ancestor- |
| | self::*[@securityEnable=true]/@Name |
| 4. | Finding all US color printers. |
| | /Printer/US//*[@color=1] |
| 5. | Send all users in Building 40 a broadcast message |
| | /Office/US/Redmond/40//*/@userName |

The data path expressions can be used in database access queries to specify the data that are to be retrieved for operations specified in the queries. Several examples of database queries using data path expressions are provided below. In these examples, the syntax of these queries is very similar to that of XQuery.

| | |
|---|---|
| 1. | Find all users who are under DaveD and work in Building 40. |
| | FOR $x in document(“ad”)/ServerGroupEmployee/DaveD//* |
| | $y in document(“ad”)/Office/US/Redmond/40//* |
| | WHERE $x/@username = $y/@username |
| | RETURN ... |
| 2. | Return all DaveD's Direct Report in his/her reports in a hierarchical format. |
| | FOR $x in document(“ad”)/ServerGroupEmployee/DaveD/* |
| | RETURN |
| | <DaveOrgChart> |
| | $x |
| | </DaveOrgChart> |
| 3.. | Return Union of all persons who worked in UDDI projects and developers who are at |
| | Cost Center 12504. |
| | FOR $x in document(“ad”)/Projects/Windows/DirectoryServices/UDDI//* |
| | $y in document(“ad”)/Enterprise//*[@costCenter=’12504’) |
| | RETURN |
| | <Result> |
| | <$x/@Name> |
| | <$y/@Name> |
| | </Result> |
| 4. | Identify managers that are common to Bob and Alice. |
| | FOR $x in document(“ad”)/OrgChart//[@Name=’Bob’]/ancestor-or-self::* |
| | $y in document(“ad”)/OrgChart//*[@Name=’Alice’)/ancestor-or-self::* |
| | WHERE $x = $y |
| | RETURN |
| | <Result> |
| | <$x/@Name> |
| | </Result> |

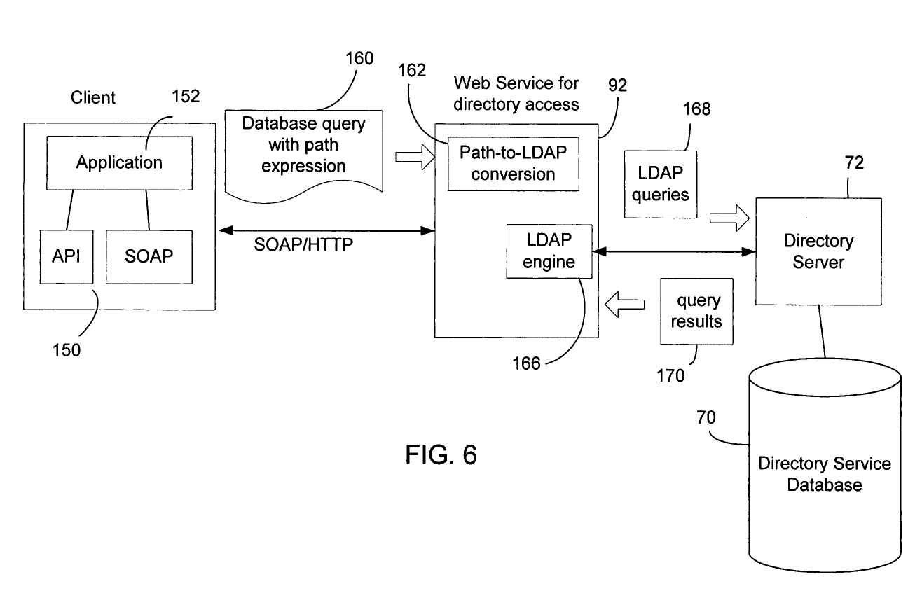

Referring to FIG. 6, in a preferred embodiment, the client is provided with Application Programming Interface (API) functions 150 that the application 152 on the client machine can call to form the data path expressions and queries using such expressions for accessing the directory service. The queries using the data path expressions are put in a request message 160 that is sent via SOAP over HTTP or other transport protocol to the Web service 92 for directory access. The Web service 92 includes a module 162 for converting the queries based on the data path expressions into LDAP queries for carrying out the requested directory data access. The LDAP engine 166 of the Web service then sends the LDAP queries to the database server 72 to retrieve the object data. It will be appreciated that although the data path expression may appear to be simple, the corresponding LDAP queries may actually be quite complicated and may require recursive or iterative execution of some queries to locate and retrieve all data specified by one data path expression. It can be seen that a significant advantage of this arrangement is that the client does not need to worry about traversing the data links defined by the path itself, because the database engine does the complex queries on behalf of the client. Having this architecture allows several benefits. First, it reduces the traffic between the client and the server, since the server will return the result that has already been processed. Second, it enables administrative control on the server, which could prevent unauthorized access or restrict the access of an abusive user of the system. Moreover, the server could optimize the query, not being limited to the LDAP filters. The server could internally implement a query processor optimized for carrying out the database search based on location path expressions.

To illustrate how the location path expressions are used in searching for the desired data, two examples are provided here. The Manager-DirectReports relationship can be modeled as:
Source: Class:Person Attribute:DirectReports
Target: Class:Person Attribute:Manger
   By having this information, a parser of the database engine can easily traverse up and down a path, such as /OrgChart/John/Jane/Alice. In this example, the view name “OrgChart” has been defined to indicate that the view is based on the Manager-DirectReports relationship. Given this location path expression, the database engine first looks at the definition of OrgChart and learns that the relationship to be used for viewing is Manager-DirectReports, which is defined between Person objects. Thus, the first element in the location path after the view name should be a person that is named “John.” The database engine locates the Person object for John, and looks at the DirectReports attribute of John to find the Person object for Jane. Once the Jane object is found, it locates the Person object for Alice by looking at the DirectReports attribute of Jane. In another example, the location path expression is “/OrgChart/Alice/ . . . ”, where “ . . . ” denotes going up to a parent node. The search process is similar to that of the previous example, except that in this example, there is a reversal in the search direction due to the “ . . . ” element. Once the database engine finds the Person object for Alice, it tries to find Alice's manager by looking at the Manager attribute of Alice. As a result, it will find Jane.

Even though the embodiment of FIG. 6 has a Web service as an intermediary for a client to access a directory service database, it should be appreciated that the use of such an intermediary is not required to practice the present invention. As illustrated in FIG. 7, in an alternative embodiment, the client sends a request 198 containing a location path string directly to the directory service 72. The directory service 72 includes a database engine 200 that is capable of interpreting the location path string in the request 198 from the client to carry out the searches based on polyarchical relationships among the database objects.

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1-30. (canceled)

31. A computer-readable medium having stored thereon a database request data structure, the database request data structure comprising:
a first data field containing data representing a location path expression identifying a data path to requested data, the location path expression comprising:
a second data field containing data representing a view name specifying a predefined relationship between object attributes in a database that contains the requested data; and
a third data field containing data representing a plurality of path elements denoting nodes in a data path to the requested data.

32. The computer-readable medium of claim 31 wherein a path element of the location path expression is a wildcard element.

33. The computer-readable medium of claim 31 wherein a path element of the location path expression indicates a search in a reversed direction of the predefined relationship.

34. The computer-readable medium of claim 31 wherein the predefined relationship is defined between attributes of two object of a same class.

35. The computer-readable medium of claim 31 wherein the predefined relationship is defined between attributes of two objects of different classes.

36. In a networking environment, a method for a client to obtain data from a database, the method comprising:
forming a request containing a location path expression identifying a data path to requested data, the location path expression including a view name specifying a data view associated with a predefined relationship between object attributes in the database and a plurality of path elements denoting nodes in the data path to the requested data;
sending the request to a server; and
receiving the requested data.

37. The method of claim 36 wherein a path element of the location path expression is a wildcard element.

38. The method of claim 36 wherein a path element of the location path expression indicates a search in a reversed direction of the predefined relationship.

39. The method of claim 36 wherein the predefined relationship is defined between attributes of two object of a same class.

40. The method of claim 36 wherein the predefined relationship is defined between attributes of two objects of different classes.

41. The method of claim 36 wherein sending the request to a server comprises sending the request in a Simple Object Access Protocol message.

42. The method of claim 36 further comprising:
obtaining configuration information from the server, the configuration information defining relationships among attributes of objects in the database and associated view names thereof.

43. A computer-readable medium containing computer-executable instructions for performing a method for a client to obtain data from a database, the method comprising:
forming a request containing a location path expression identifying a data path to requested data, the location path expression including a view name specifying a data view associated with a predefined relationship between object attributes in the database and a plurality of path elements denoting nodes in the data path to the requested data;
sending the request to a server; and
receiving the requested data.
